(19) United States
(12) Patent Application Publication
(10) Pub. No.: US 2026/0235129 A1
(43) Pub. Date: Aug. 13, 2026

(54) DISENGAGEMENT TEST SYSTEM AND METHOD FOR A PUMP

(71) Applicant: Xi'an Space Engine Company Limited, Xi'an (CN)

(72) Inventors: Fengyu LI, Xi'an (CN); Xiaowei MA, Xi'an (CN); Xiangpeng LIANG, Xi'an (CN); Fujun SHI, Xi'an (CN); Xiaohu HE, Xi'an (CN); Dongsheng WANG, Xi'an (CN)

(21) Appl. No.: 19/643,781

(22) Filed: Apr. 9, 2026

Related U.S. Application Data
(63) Continuation of application No. PCT/CN2025/147120, filed on Dec. 30, 2025.

(30) Foreign Application Priority Data
Mar. 14, 2025 (CN) 202510305807.4

(51) Int. Cl. F04D 15/00; G01M 3/28; F02K 9/48

(52) U.S. Cl. CPC F04D 15/0088; G01M 3/2869; F02K 9/48

(57) ABSTRACT

A seal disengagement test system for a turbine oxidizer pump of an engine, includes a test console. The test console includes a pneumatic booster pump, a piping system, and control valves. The pneumatic booster pump is configured to charge nitrogen gas from a nitrogen gas source into a nitrogen storage device for pre-storage. The piping system is configured to connect the nitrogen storage device to a pump chamber of a turbine oxidizer pump to-be-tested to form disengagement test channels, the disengagement test channels comprising an airtight-path channel and a disengagement-path channel. The control valves are disposed on pipelines of the disengagement test channels, respectively. The control valves include an airtight-path pressure regulating valve configured to adjust a pressurization rate during an airtight test, a disengagement-path pressure regulating valve configured to control pressure and a pressurization rate during a disengagement test, and a pressure relief valve.

### CROSS-REFERENCE TO RELATED APPLICATIONS

This application is a continuation of International Patent Application No. PCT/CN2025/147120, filed on December 30, 2025, which claims the benefit of priority from Chinese Patent Application No. 202510305807.4, filed on March 14, 2025. The content of the aforementioned application, including any intervening amendments thereto, is incorporated herein by reference in its entirety.

### TECHNICAL FIELD

This application relates to non-standard assembly process equipment, and more particularly to a disengagement test system and method for a pump.

### BACKGROUND

Currently, testing of the seal performance of liquid rocket engine turbine pumps is conducted in a conventional manner using a nitrogen cylinder connected to a manually operated airtight test console. During operation, personnel manually actuate valves to adjust valve opening degrees and rely on a pointer-type pressure gauge to control a seal disengagement of a turbine oxidizer pump. The entire procedure depends on manual operation by assembly personnel and therefore requires a high level of skill and experience. The turbine pump is the only high-speed rotating component in a rocket engine. As the “heart” of the rocket engine, the performance of the turbine pump directly affects engine operation.

A test method for the seal disengagement performance of the turbine oxidizer pump relies on mechanization and automation procedures of the equipment. Traditionally, the seal disengagement test of the turbine oxidizer pump has been conducted fully manually using conventional airtight test consoles. A speed at which an operator manually opens a valve may affect a pressure measured at the moment of turbine-end seal disengagement. If the operator manually opens the valve too slowly, the turbine-end seal disengagement test may become an airtight test, and the dynamic seal cannot disengage instantaneously, instead exhibiting slight leakage after gradual pressurization, which conflicts with the seal design goal and product testing requirements.

Additionally, due to limitations of the capacity of the standard nitrogen cylinder and pipeline diameters, when the operator uses conventional nitrogen test consoles to open the disengagement valve for disengagement tests, an inflow rate into the pump chamber of the turbine oxidizer pump is restricted by diameters of the cylinder outlet pipeline and the capacity of the nitrogen cylinder. Test data for seal disengagement are therefore influenced by non-product factors, resulting in doubt on the reliability of many test results.

As discussed above, the shortcomings of conventional seal disengagement test systems composed of nitrogen cylinders connected to the test console are as follows: the seal disengagement test process relies on manual operation by assembly personnel, requiring a high level of skill and experience, and test data are heavily influenced by human factors. Moreover, due to limitations of the capacity of the standard nitrogen cylinder and the pipeline diameters, when the turbine-end seal approaches the disengagement threshold, the inflow to the pump chamber may reach a dynamic balance with the seal leakage at the turbine-end seal, resulting in a failure of an instantaneous disengagement. At the same time, the pointer-type pressure gauge may introduce reading errors at the moment of seal disengagement, affecting the monitoring accuracy of test results.

### SUMMARY

The present disclosure aims to overcome the shortcomings in the related art by providing a disengagement test system and method for a pump, avoiding test uncertainty caused by manual operation, significantly simplifying the seal testing process of the turbine oxidizer pump, and improving the assembly quality and efficiency of the turbine oxidizer pump.

In a first aspect, a seal disengagement test system for a liquid oxygen turbopump of a high-thrust engine is provided and comprises:

a test console, comprising a pneumatic booster pump, a piping module, and control valves, wherein:

the pneumatic booster pump is configured to charge nitrogen gas from a nitrogen gas source into a nitrogen storage device for pre-storage;

the piping module is configured to connect the nitrogen storage device to a pump chamber of a liquid oxygen turbopump to-be-tested to form testing channels, the testing channels comprising an air tightness testing channel and a disengagement testing channel;

the control valves are disposed on pipelines of the testing channels, respectively; and

the control valves comprise an airtight-path pressure regulating valve configured to adjust a pressurization rate during an airtight test, a disengagement-path pressure regulating valve configured to control pressure and a pressurization rate during a disengagement test, and a pressure relief valve configured to open when a pressure of the seal disengagement test system reaches a safety pressure threshold;

the nitrogen storage device, configured to store the nitrogen gas as a gas reserve for testing;

a sensor, configured to acquire a sealing pressure of the liquid oxygen turbopump to-be-tested;

a displacement monitoring device, configured to monitor a displacement of a seal in the liquid oxygen turbopump to-be-tested during a seal disengagement process; and

an automatic control unit, configured to control opening and closing of the seal and to monitor a pressure in the pump chamber of the liquid oxygen turbopump;

wherein the automatic control unit is configured to:

control the pneumatic booster pump to charge the nitrogen gas from the nitrogen gas source into the nitrogen storage device;

control the airtight-path pressure regulating valve to perform the airtight test on the liquid oxygen turbopump to-be-tested and to control the disengagement-path pressure regulating valve to perform a seal disengagement test on the liquid oxygen turbopump to-be-tested;

after completion of the airtight test and the seal disengagement test, plot a seal disengagement curve of the liquid oxygen turbopump to-be-tested during the seal disengagement test based on the sealing pressure acquired by the sensor and the displacement acquired by the displacement monitoring device, thereby enabling automatic testing, automatic data acquisition, and automatic curve plotting for the seal disengagement test of the liquid oxygen turbopump to-be-tested.

In some embodiments of the present disclosure, the air tightness testing channel is configured for an airtight test under a pressure of 0.9 MPa, the disengagement testing channel is configured for a disengagement test under a pressure of 10 MPa, and the air tightness testing channel is independent from the disengagement testing channel.

In some embodiments of the present disclosure, a volume of the nitrogen storage device is at least 120 L.

In some embodiments of the present disclosure, the piping module is maintained in a clean and oil-free condition prior to manufacturing and assembly.

In some embodiments of the present disclosure, the pressure relief valve is configured to detect a pressure value for operational safety of the liquid oxygen turbopump to-be-tested; and during the seal disengagement test, when high-pressure nitrogen gas is charged and a seal fails to disengage normally due to an inherent fault of the seal, the pressure relief valve is controlled to open to release pressure of the entire seal disengagement test system in response to that the pump chamber of the liquid oxygen turbopump to-be-tested reaches the safety pressure threshold.

In some embodiments of the present disclosure, the sensor is configured to acquire a gauge pressure at the seal of the pump chamber of the liquid oxygen turbopump to-be-tested, with a sampling frequency greater than 50 Hz and a pressure measurement accuracy not greater than 0.25% full scale (FS).

In some embodiments of the present disclosure, the displacement monitoring device is implemented as a laser displacement sensor that is configured to measure the displacement of a seal in the liquid oxygen turbopump to-be-tested during the seal disengagement process, with a measurement range not less than 20 mm and an accuracy not greater than 0.05% FS.

In a second aspect, a disengagement test method for a liquid oxygen turbopump of a high-thrust engine, implemented by the seal disengagement test system in the first aspect, comprises:

charging the nitrogen storage device prior to testing;

stopping the charging, by the automatic control unit, after the nitrogen storage device reaches the safety pressure threshold;

setting a pressure value for the airtight test of the liquid oxygen turbopump to-be-tested, starting a test program to perform an airtight detection on the liquid oxygen turbopump to-be-tested, and displaying in real time, on the test console, a change of the pressure in the pump chamber of the liquid oxygen turbopump to-be-tested;

setting a pressure value for the seal disengagement test of the liquid oxygen turbopump to-be-tested, comprising setting a pressure stabilization value for a pressurization process of the liquid oxygen turbopump to-be-tested and subsequently setting, via the test console, a pressure peak value for the seal disengagement test; and

starting a seal disengagement test program to perform a turbine-end seal disengagement test on the liquid oxygen turbopump to-be-tested, comprising: detecting a displacement change of the displacement monitoring device during the seal disengagement test, monitoring a gauge pressure value of the pump chamber of the liquid oxygen turbopump to-be-tested in real time through the test console, and plotting the seal disengagement curve on the test console.

In some embodiments of the present disclosure, the pressure value for the airtight test of the liquid oxygen turbopump to-be-tested comprises 0.3 MPa, 0.6 MPa, and 1.0 MPa, and the airtight-path pressure regulating valve of the test console is configured to regulate the pressure value, with a pressure regulation range of 0 - 2.0 MPa and an accuracy of ±1% FS.

In some embodiments of the present disclosure, the turbine-end seal disengagement test comprises:

performing a uniform-speed slow pre-pressurization process to control a charging pressure to approximately 0.9 MPa; and

thereafter instantaneously increasing a pressure in the disengagement testing channel, in which the nitrogen gas stored in the nitrogen storage device is instantaneously charged into the liquid oxygen turbopump to-be-tested, and during a charging pressure stage of 1.5 MPa -2.5 MPa, a pressurization rate △Pt is not less than 1.0 MPa per 20 seconds.

Compared with the related art, the present disclosure has the following the advantages.

The seal disengagement test system for the liquid oxygen turbopump of the present disclosure is an integrated test system combining airtight test and disengagement test. The air tightness testing channel and disengagement testing channel are independent from each other and controlled by separate pipeline systems, allowing independent testing of airtight performance and turbine-end seal disengagement performance of the liquid oxygen turbopump. The air tightness testing channel includes four channels capable of performing airtight tests in the range of 0 - 2.5 MPa, and the disengagement testing channel includes three channels capable of performing disengagement tests in the ranges of 0 - 6 MPa and 0 - 10 MPa.

The seal disengagement test system of the present disclosure employs an industrial personal computer (IPC) and software control system for automatic control by applying control actions to electric regulating valves, electric proportional valves, electric pressure relief valves, and solenoid valves. Accordingly, adjustment and control of both the air tightness testing channel and disengagement testing channel are realized, thereby achieving testing functions. The test system features high automation, high integration, and high test accuracy, avoids test uncertainty caused by manual operation, substantially simplifies the seal testing process of the liquid oxygen turbopump, improves assembly quality and efficiency of the liquid oxygen turbopump, and simultaneously reduces labor intensity for frontline personnel.

### BRIEF DESCRIPTION OF THE DRAWINGS

Various advantages and benefits will become apparent to those of skill in the art in accordance with the detailed description of preferred embodiments below. The accompanying drawings are provided for illustration only and are not intended to limit the present disclosure. Identical reference numerals in the accompanying drawings denote identical components.

FIG. 1 is a schematic view of a seal disengagement test system for a liquid oxygen turbopump.

FIG. 2 is a schematic view illustrating airtight interfaces, disengagement interfaces, and pressure monitoring interfaces of the seal disengagement test system.

FIG. 3 is a schematic view illustrating an industrial personal computer (IPC), a control panel, and a printer of the seal disengagement test system.

FIG. 4 is a schematic view illustrating a nitrogen storage device and gas supply pipelines.

FIG. 5 is a schematic structural view illustrating an internal nitrogen cylinder of the nitrogen storage device and a housing.

FIG. 6 is a schematic diagram illustrating a connection of a laser displacement sensor.

FIG. 7 is a schematic diagram illustrating a piping module.

### DETAILED DESCRIPTION OF EMBODIMENTS

In order to better understand the above technical solutions, the technical solutions of the present disclosure are described in detail below with reference to the accompanying drawings and specific embodiments. It may be understood that the embodiments of the present disclosure and the specific features in the embodiments are detailed descriptions of the technical solutions of the present disclosure, rather than limitations on the technical solutions of the present disclosure. Under the condition of no conflict, the embodiments of the present disclosure and the technical features in the embodiments may be combined with each other.

The following further describes, in detail with reference to the accompanying drawings, a seal disengagement test system and method for a pump provided by the embodiments of the present disclosure. Specific implementations may include the following.

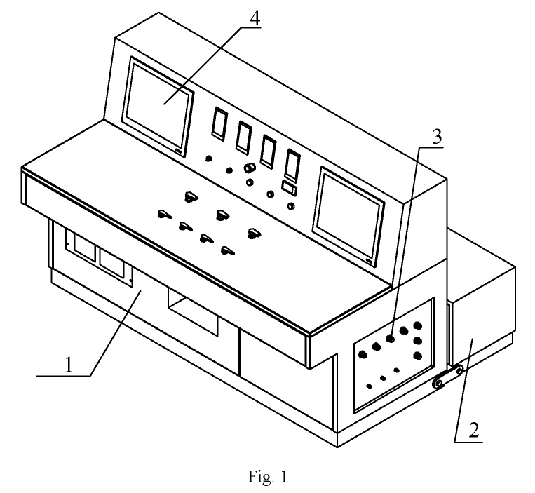

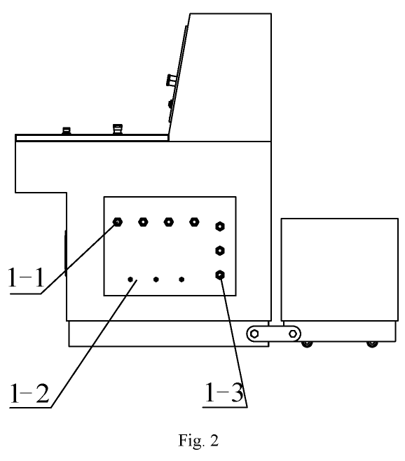

As shown in FIGS. 1 and 2, the seal disengagement test system for the liquid oxygen turbopump includes a test console 1, a nitrogen storage device 2, a piping module 3, an automatic control unit 4, and a high-precision displacement monitoring device 5. The test console 1 includes a booster pump, a stainless steel piping module, control valves, and console structural components, where the booster pump, the stainless steel piping module, the control valves are inside the test console 1. The nitrogen storage device 2 includes a large-capacity nitrogen cylinder and a separate mobile cylinder carrier structure. The piping module 3 includes disengagement-path pipelines, airtight-path pipelines, and a cable reel. The automatic control unit 4 includes an industrial personal computer (IPC) and data acquisition/control cards, is connected to sensors and control valves in each channel, and operated via a LabVIEW-based software platform. The high-precision displacement monitoring device 5 includes a laser displacement sensor.

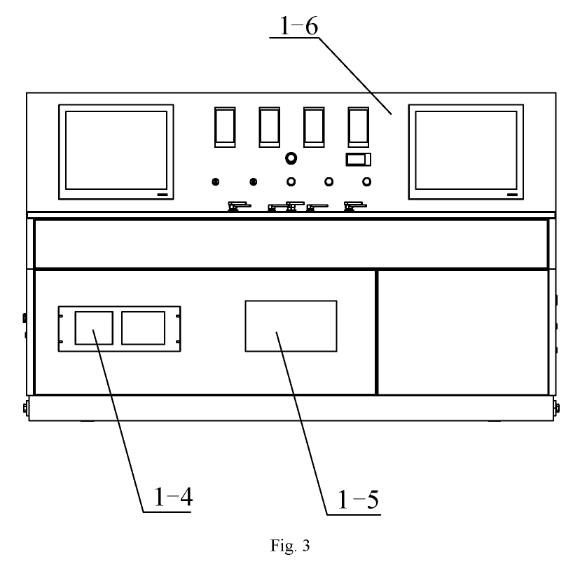

As shown in FIG. 3, a main body of the test console 1 is of a piano-type configuration, with an exterior formed by welded steel profiles and steel plates, and a surface treated by electrostatic spray coating. The interior of main body of the test console 1 includes a pneumatic booster pump, the stainless steel piping module, and the control valves. The pneumatic booster pump is configured to pump a plant nitrogen gas source into the nitrogen storage device 2 for pre-storage. The stainless steel piping module serves as various testing channels required by the test console, and the control valves are connected to respective independent test channel pipelines. A pressure regulating valve is configured to adjust the pressurization process and pressurization rate for the airtight test, while another pressure regulating valve is configured to control the pressure and the pressurization rate for the disengagement test.

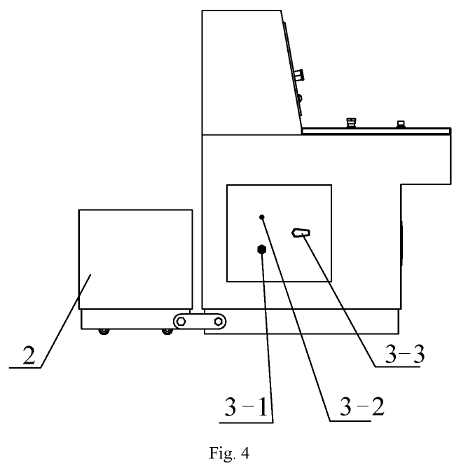

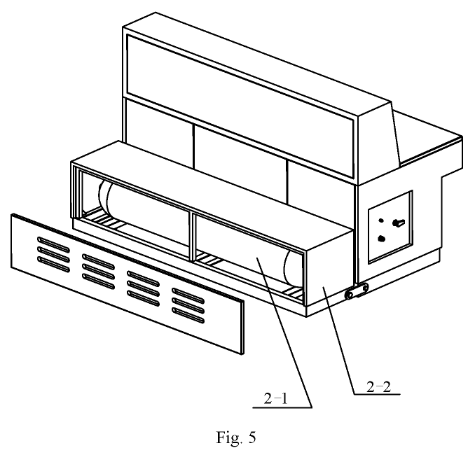

As shown in FIG. 4 and FIG. 5, the nitrogen storage device 2 includes a large-capacity nitrogen storage cylinder and a separable mobile cylinder carrier structure. The nitrogen storage cylinder stores nitrogen gas pumped from the plant through the pneumatic booster pump, serving as a gas reserve for subsequent tests. The separable mobile cylinder carrier structure is formed by welded steel plates and internally provided with a truss structure for installation and fixation of nitrogen cylinders.

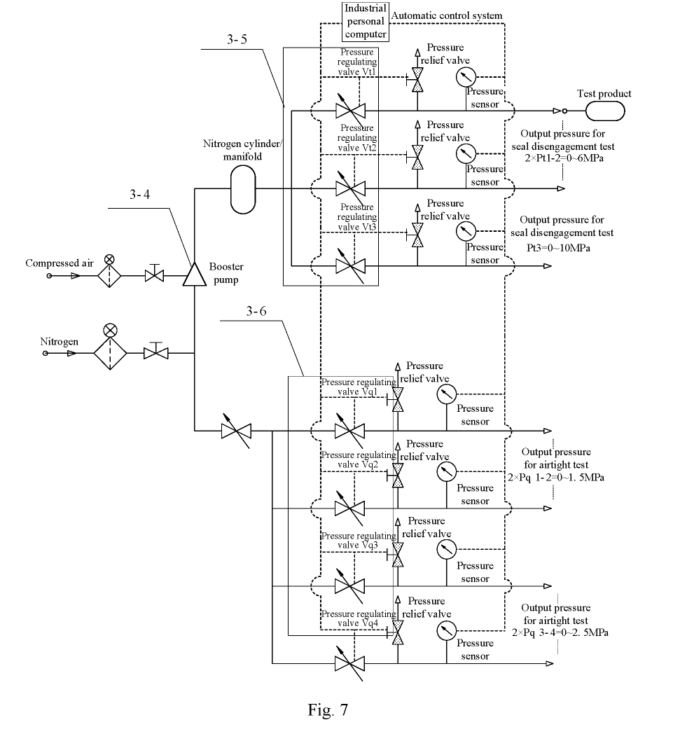

As shown in FIG. 7, the piping module 3 is configured for pipeline connection between the test console and a test product.

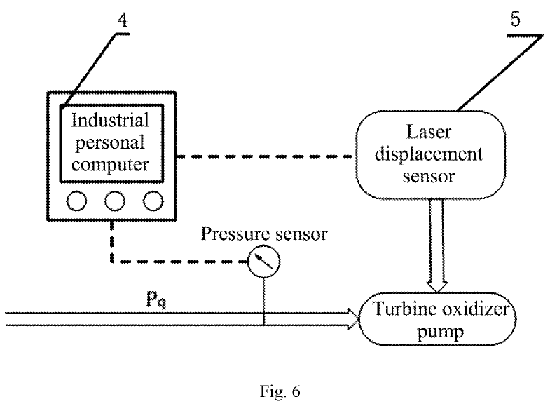

As shown in FIG. 6, the high-precision displacement monitoring device 5 includes a laser displacement sensor, and is capable of high-precision displacement monitoring within a certain distance range.

The automatic control unit 4 is established using the IPC and data acquisition/control cards, and is developed based on the LabVIEW software platform, and is configured to control various test channels and feed back respective pressure monitoring values. An operator may drive a plant nitrogen gas source to charge nitrogen into the nitrogen cylinder through control software, and control pipeline booster pumps, pressure regulating valves, and pressure relief valves through automatic control software, so as to respectively perform the airtight test and the seal disengagement test on the turbine pump. After completion of the tests, the automatic control unit 4 transmits a sealing pressure collected by sensors back to the control software, automatically plots a turbine-end seal disengagement curve during the test process, thereby eventually realizing automatic testing, automatic data acquisition, and automatic plotting for the seal disengagement of the liquid oxygen turbopump.

The seal disengagement test system itself stores gas, and nitrogen gas from the nitrogen gas source or a nitrogen gas manifold in the plant is charged into the nitrogen storage device 2 through the test console 1. A volume of the nitrogen storage device is 120 L.

The piping module 3 is maintained in a clean and oil-free condition prior to manufacturing and assembly.

Safety of the entire liquid oxygen turbopump is ensured by a pressure value of the pressure relief valve of the test console 1. When high-pressure nitrogen gas is charged during a disengagement test and a seal fails to disengage normally due to an inherent fault of the seal, the pressure relief valve is controlled to open to release pressure of the entire seal disengagement test system in response to that the pump chamber of the liquid oxygen turbopump to-be-tested reaches the safety pressure threshold.

The sensor is configured to acquire a gauge pressure at the seal of the pump chamber of the liquid oxygen turbopump to-be-tested, with a sampling frequency greater than 50 Hz and a pressure measurement accuracy not greater than 0.25% full scale (FS).

The displacement monitoring device 5 is implemented as a laser displacement sensor that is configured to measure the displacement of a seal in the liquid oxygen turbopump to-be-tested during the seal disengagement process, with a measurement range not less than 20 mm and an accuracy not greater than 0.05% FS.

The seal disengagement test system for the liquid oxygen turbopump operates according to the following steps.

Before testing, the gas supply pipeline is connected, and a connection between the plant nitrogen gas source and the test console is established. An outlet of the test console is connected to a test inlet of the pump chamber of the liquid oxygen turbopump to-be-tested. An operator sets parameters in the control software and uses the seal disengagement test system to charge nitrogen into the nitrogen cylinder. After pressure inside the nitrogen cylinder reaches the safety pressure threshold, the control system stops charging the nitrogen cylinder.

The operator sets, through the control software, pressure values for the airtight test of the liquid oxygen turbopump. Test pressures of 0.3 MPa, 0.6 MPa, and 1.0 MPa are respectively selected, a test program is started, and the pressure regulating valve controls the nitrogen cylinder to perform airtight pressurization of the pump chamber of the liquid oxygen turbopump to-be-tested. Upon reaching the safety pressure threshold, the pressure regulating valve is closed, an entire pipeline outlet connected to the liquid oxygen turbopump is shut off from the front-end test console, and then the liquid oxygen turbopump performs an airtight test. A pressure sensor at the pipeline outlet feeds back pressure variations inside the pump chamber in real time.

The operator sets, through the control software, pressure values for the seal disengagement test of the liquid oxygen turbopump. A pressure stabilization value of 0.9 MPa for a pressurization process of the test console is first set, and then the control system sends a disengagement test command. The command causes the pressure regulating valve to open with an opening degree of at least 90%, and the nitrogen gas in the nitrogen storage device is rapidly charged into a pump chamber of a test product through a pneumatic regulating valve. When the chamber pressure increases to approximately 2.5 MPa, the turbine-end seal of the liquid oxygen turbopump is expected to disengage instantaneously. The high-precision displacement monitoring device 5 detects displacement variations during the seal disengagement process. One pressure sensor is connected through a pipeline to a vicinity of an inner cavity of a disengagement-type seal of the liquid oxygen turbopump, collects pressure data at the disengagement-type seal, detects the gauge value of the seal cavity of the liquid oxygen turbopump in real time, and stores the data in a computer. A software control system plots a seal disengagement pressure variation curve.

In a solution provided by the embodiments of the present disclosure, as shown in FIG. 1, the seal disengagement test system for the high-thrust engine of the liquid oxygen turbopump adopted by the present disclosure includes the test console 1, the nitrogen storage device 2, the piping module 3, the automatic control unit 4, and the high-precision displacement monitoring device 5. The test console 1 includes the main body, a pipeline interface 1-1 for the airtight test, a gauge pressure pipeline connector 1-2, a pipeline connector 1-3 for the seal disengagement test, an IPC 1-4, a data printer 1-5, a control panel 1-6, and the like. The nitrogen storage device 2 includes a gas storage cylinder 2-1 of 120 L and a gas storage cylinder enclosure 2-2. The piping module 3 includes a compressed air pipeline 3-1, a nitrogen gas source pipeline 3-2, a pressure relief pipeline 3-3, a booster pump 3-4, a disengagement-path pressure regulating valve 3-5, and an airtight-path pressure regulating valve 3-6. The automatic control unit 4 is developed based on a LabVIEW software platform and is configured to control opening and closing of the seal and feed back respective pressure monitoring values. The automatic control unit 4 includes a human–machine operation panel, a control cabinet, a manual operation handle, and the like. The high-precision displacement monitoring device 5 includes a laser displacement sensor.

In the case of testing the liquid oxygen turbopump, the assembly and testing steps are as follows.

Before testing, an operator connects the compressed air pipeline 3-1 and connects the nitrogen gas source pipeline 3-2 between the plant nitrogen gas source and the test console. Through an operation interface of the automatic control unit 4, a target gas source pressure of the nitrogen storage device 2 is set, and then the booster pump 3-4 operates to pressurize the nitrogen storage device. After pressure inside the nitrogen storage cylinder reaches the safety pressure threshold, the control system stops charging the nitrogen storage cylinder. An outlet of the pipeline interface 1-1 of the test console for the airtight test is connected to a test inlet of the pump chamber of the liquid oxygen turbopump to-be-tested.

Through an operation interface of the automatic control unit 4 for the airtight test, the operator sets pressure values for the airtight test of the liquid oxygen turbopump: 0.3 MPa, 0.6 MPa, and 1.0 MPa. The test program is started, and the IPC 1-4 sends a command to the pressure regulating valve 3-6 in a corresponding path of an airtight pipeline, to charge the nitrogen gas into the pump chamber of the liquid oxygen turbopump. When the gauge pressure connector 1-2 indicates that a pressure in the pump chamber of the liquid oxygen turbopump reaches a set pressure, pressurization is stopped. Subsequently, the operator performs airtight detection, and the control panel 1-6 of the test console displays pressure variations inside the pump chamber in real time. After completion of the airtight test, stored test pressure data may be printed by the data printer 1-5.

The operator connects the gauge pressure connector 1-2 to a corresponding measuring point near the disengagement seal of the liquid oxygen turbopump. Through a disengagement test interface of the automatic control unit 4, a stabilization pressure for a first stage of the disengagement test is set. The test program is started, and the industrial control computer 1-4 sends a command to the pressure regulating valve 3-5 in a corresponding path of the disengagement-path pipeline, to slowly pressurize to a set pressure. Subsequently, the IPC 1-4 controls the pressure regulating valve 3-5 to rapidly open, to perform an instantaneous high-volume pressurization. The turbine-end seal disengagement test is performed on the liquid oxygen turbopump. The high-precision displacement monitoring device 5 detects displacement variations during the seal disengagement test, and a console software interface 4 detects the gauge value of the seal cavity of the liquid oxygen turbopump in real time and plots a curve. Stored seal disengagement pressure data may be printed by the data printer 1-5.

Apparently, those of skill in the art can make various modifications and variations to the present disclosure without departing from the spirit and scope of the present disclosure. Accordingly, if such modifications and variations fall within the scope of the claims of the present disclosure and equivalent technologies thereof, the present disclosure is also intended to encompass such modifications and variations.

Content not described in detail in the specification of the present disclosure belongs to well-known technologies of those skilled in the art.

What is claimed is:

1. A seal disengagement test system for a liquid oxygen turbopump of an engine, comprising:
a console;
a nitrogen storage device;
a sensor;
a displacement monitoring device; and
an automatic control unit;
wherein the console comprises a pneumatic booster pump, a piping module and a plurality of control valves;
the pneumatic booster pump is configured to charge nitrogen gas from a nitrogen gas source into the nitrogen storage device for storage;
the piping module is configured to connect the nitrogen storage device to a pump chamber of a to-be-tested liquid oxygen turbopump to form a plurality of testing channels, wherein the plurality of testing channels comprise an air tightness testing channel and a disengagement testing channel;
the plurality of control valves are disposed on the plurality of testing channels, respectively; and
the plurality of control valves comprise a first pressure-regulating valve, a second pressure-regulating valve and a pressure relief valve; the first pressure-regulating valve is configured to adjust a pressurization rate during an air tightness test, and the second pressure-regulating valve is configured to control a pressure and a pressurization rate during a disengagement test; and the pressure relief valve is configured to maintain a pressure of the seal disengagement test system not higher than a safety pressure threshold;
the nitrogen storage device is configured to store the nitrogen gas;
the sensor is configured to acquire a sealing pressure of the to-be-tested liquid oxygen turbopump;
the displacement monitoring device is configured to monitor a displacement of a seal in the to-be-tested liquid oxygen turbopump during a seal disengagement process;
the automatic control unit is configured to control opening and closing of the seal and to monitor a pressure in the pump chamber of the to-be-tested liquid oxygen turbopump;
wherein the automatic control unit is configured to:
control the pneumatic booster pump to charge the nitrogen gas from the nitrogen gas source into the nitrogen storage device;
control the first pressure-regulating valve to perform the air tightness test on the to-be-tested liquid oxygen turbopump and control the second pressure-regulating valve to perform a seal disengagement test on the to-be-tested liquid oxygen turbopump;
after completion of the air tightness test and the seal disengagement test, plot a seal disengagement curve of the to-be-tested liquid oxygen turbopump during the seal disengagement test based on the sealing pressure acquired by the sensor and the displacement acquired by the displacement monitoring device, thereby enabling automatic testing, automatic data acquisition, and automatic curve plotting for the seal disengagement test of the to-be-tested liquid oxygen turbopump.

2. The seal disengagement test system according to claim 1, wherein the air tightness testing channel is configured for an airtightness test under a pressure of 0.9 MPa; the disengagement testing channel is configured for a disengagement test under a pressure of 10 MPa; and the air tightness testing channel is independent from the disengagement testing channel.

3. The seal disengagement test system according to claim 1, wherein a volume of the nitrogen storage device is at least 120 L.

4. The seal disengagement test system according to claim 1, wherein the piping module is maintained in a clean and oil-free condition prior to manufacturing and assembly.

5. The seal disengagement test system according to claim 1, wherein
the pressure relief valve is configured to ensure operational safety of the to-be-tested liquid oxygen turbopump; and
in response to a case that the nitrogen gas is charged and the seal fails to disengage normally due to an inherent fault of the seal during the seal disengagement test, the pressure relief valve is configured to be opened to release pressure of the seal disengagement test system once the pump chamber of the to-be-tested liquid oxygen turbopump reaches the safety pressure threshold.

6. The seal disengagement test system according to claim 1, wherein the sensor is configured to acquire a gauge pressure at a seal of the pump chamber of the to-be-tested liquid oxygen turbopump, with a sampling frequency greater than 50 Hz and a pressure measurement accuracy not greater than 0.25% full scale (FS).

7. The seal disengagement test system according to claim 1, wherein the displacement monitoring device is a laser displacement sensor that is configured to measure the displacement of the seal in the to-be-tested liquid oxygen turbopump during the seal disengagement process, with a measurement range not less than 20 mm and an accuracy not greater than 0.05% FS.

8. A disengagement test method for a liquid oxygen turbopump of an engine, the disengagement test method being implemented by the seal disengagement test system according to claim 1, and the disengagement test method comprising:
charging the nitrogen storage device with nitrogen gas prior to testing;
after the nitrogen storage device reaches the safety pressure threshold, controlling, by the automatic control unit, to stop charging the nitrogen storage device;
setting a pressure value for the air tightness test of the to-be-tested liquid oxygen turbopump, starting a test program to perform the air tightness test on the to-be-tested liquid oxygen turbopump, and displaying in real time, on the console, a change of the pressure in the pump chamber of the to-be-tested liquid oxygen turbopump;
setting a pressure value for the seal disengagement test of the to-be-tested liquid oxygen turbopump, comprising:
setting a target stabilization pressure for a pressurization process of the to-be-tested liquid oxygen turbopump and setting, via the console, a pressure peak value for the seal disengagement test; and
starting a seal disengagement test program to perform a turbine-end seal disengagement test on the to-be-tested liquid oxygen turbopump; monitoring, by the displacement monitoring device, a displacement change during the seal disengagement test; monitoring, by the console, a gauge pressure value of the pump chamber of the to-be-tested liquid oxygen turbopump in real time; and plotting the seal disengagement curve on the console.

9. The disengagement test method according to claim 8, wherein the pressure value for the air tightness test is respectively set to 0.3 MPa, 0.6 MPa and 1.0 MPa, and the pressure value is regulated through the first pressure-regulating valve within the console, with a pressure regulation range of 0 - 2.0 MPa and an accuracy of ±1% FS.

10. The disengagement test method according to claim 8, wherein the turbine-end seal disengagement test comprises:
performing a constant-rate pre-pressurization process to control a charging pressure to 0.9 MPa; and
instantaneously increasing a pressure in the disengagement testing channel to charge the nitrogen gas stored in the nitrogen storage device into the to-be-tested liquid oxygen turbopump, wherein during a stage with the charging pressure of 1.5 MPa -2.5 MPa, a pressurization rate △Pt is not less than 1.0 MPa per 20 seconds.
